(19) United States
(12) Patent Application Publication
(10) Pub. No.: US 2009/0252071 A1
(43) Pub. Date: Oct. 8, 2009

(54) METHOD AND DEEVICE FOR NETWORK MESSAGING

(75) Inventors: Jukka K. Nurminen, Espoo (FI); Imre Kelenyi, Budapest (HU)

Correspondence Address: FOLEY & LARDNER LLP, P.O. BOX 80278, SAN DIEGO, CA, 92138-0278, US

(73) Assignee: Nokia Corporation

(21) Appl. No.: 12/061,576

(22) Filed: Apr. 2, 2008

(51) Int. Cl. G08C 17/00

(52) U.S. Cl. 370/311

(57) ABSTRACT

Methods and devices for responding to network messages based on a status of one or more parameters of a device are disclosed. In one embodiment, these methods allow efficient energy management of a network device by monitoring the power levels associated with the device. In particular, if the battery power level associated with the device drops below a predetermined threshold, the device may decide not to respond to certain types of messages received from the network. Furthermore, if the battery power is within a predetermined range, the device may respond to network messages according to a probability value. The disclosed methods may be implemented in mobile devices that operate on a network with distributed hash tables (DHTs).

### FIELD OF INVENTION

This invention relates to communication networks and devices. In particular, the present invention relates to configuring device responses to network messages in accordance with energy status of the device.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Distributed Hash Tables (DHTs) are among the key data structures of peer-to-peer (P2P) networks that facilitate storage and retrieval of information from participating nodes in the network. As opposed to techniques that rely on centralized servers to locate a desired node, DHTs allow identification, storage, and retrieval of information from one or more nodes on the network without the need for centralized coordination. In addition, DHT's provide enhanced scalability and fault tolerance that allow a plurality of nodes to efficiently and continuously join or leave the network.

These and other features of DHTs have made them attractive candidates in a variety of applications, such as content distribution, peer-to-peer session initiation protocol (P2PSIP), email, Instant Messaging (IM), Voice over IP (VoIP), Mobile Ad-hoc Networks (MANet) and other systems and applications that can benefit from DHT-enabled distributed services. However, a key problem with devices that utilize a DHT is increased power consumption. This increase may be attributed to the large number of queries initiated by a growing number of active nodes on the network. These queries, and associated responses, may further contribute to network congestion and increase the usage costs associated with using the network. The issues of increased power consumption and network traffic may be even more critical for devices that are subject to power consumption constraints, for example, mobile devices that usually operate on limited battery power.

### SUMMARY OF THE INVENTION

Methods and devices are therefore provided to efficiently manage energy consumption of communication devices that utilize distributed services. One aspect of the present invention relates to a method for responding to network messages, comprising receiving one or more network messages at a network device, receiving information related to a status of one or more parameters of the device, and responding to the one or more messages in accordance with the type of the messages and the information. In one embodiment, the status of one or more parameters comprises energy status of the device, and in another embodiment, the status of one or more parameters comprises the roaming status of the device. According to another embodiment, the one or more messages correspond to a network utilizing distributed hash tables (DHTs). In yet another embodiment, the messages comprise at least one of a query and a response message.

According to one embodiment of the present invention, the information indicates a connectivity to an external power source, while in another embodiment, the information indicates a connectivity to a battery. In yet another embodiment, the information comprises a battery power level associated with the network device. In another embodiment, the information is measured periodically.

In accordance with another embodiment of the present invention, one or more of the messages comprise a response to a message initiated by the device and the responding comprises processing the response regardless of the information. In another embodiment, one or more of the messages comprise a query initiated by another device and the responding is effected in accordance with the information and a probability value associated with the likelihood of not responding to the messages. In one embodiment, the information indicates a connectivity to an external power supply and the probability value is zero, and in another embodiment, the information indicates a battery power level below a predetermined threshold and the probability value is one. In yet another embodiment, the information indicates a connectivity to a battery and the probability value is greater than zero but less than one.

Another aspect of the present invention relates to a device comprising a receiver configured to receive one or more network messages at a network device, a measurement device configured to collect information related to a status of one or more parameters of the device, and a processor configured to respond to the one or more messages in accordance with the type of the messages and the information.

In another aspect of the present invention, an apparatus is disclosed, comprising a processor, and a memory unit communicatively connected to the processor and including a computer code for receiving one or more network messages at a network device, a computer code for receiving information related to a status of one or more parameters of the device, and a computer code for responding to the one or more messages in accordance with the type of the messages and the information. Another aspect of the present invention relates to a computer program product embodied on a computer-readable medium, comprising a computer code for receiving one or more network messages at a network device, a computer code for receiving information related to a status of one or more parameters of the device, and a computer code for responding to the one or more messages in accordance with the type of the messages and the information.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates an exemplary node in a DHT network;

FIG. 2 illustrates a flow diagram in accordance with an exemplary embodiment of the present invention;

FIG. 3 illustrates an exemplary node in a DHT network in accordance with an exemplary embodiment of the present invention;

FIG. 4 illustrates an exemplary block diagram of a device which may be utilized in accordance with the various embodiments of the present invention;

FIG. 5 illustrates a perspective view of an exemplary electronic device which may be utilized in accordance with the various embodiments of the present invention; and

FIG. 6 is a schematic representation of the circuitry which may be included in the electronic device of FIG. 5.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

DHT research was originally motivated, in part, by P2P systems, which took advantage of resources distributed across the Internet to access and retrieve information that reside at one or more nodes. One model for implementing such services relies on a central index server that contains a list of all files within each individual node. In response to queries, the central server searches its database, finds the node containing the desired information, and refers the inquiry to that node. The centralized control model, however, may be vulnerable to hacking and denial of service attacks. To overcome these problems, some system utilize a flooding query model, in which each query is broadcast to other nodes in the network. While avoiding a single point of failure by decentralizing the network operations, the flooding query model is inefficient since it unnecessarily broadcasts all queries to all devices on the network. These deficiencies are further improved in systems that employ a key-based search strategy to confine the search/query to a limited number of nodes. To this end, each object of interest, such as a file, is associated with a key value that is used to route a query through a subset of nodes on the network. DHT enables one such key-based routing and searching mechanism that provides a decentralized architecture in an efficient and reliable fashion. In BitTorrent and P2P SIP applications, for example, the IP address of participants may be stored in the DHT to enable the key-based search strategy.

A DHT allows a group of distributed hosts to collectively manage a mapping from keys to data values, without a fixed hierarchy, and with very little human assistance. DHTs were first introduced in 2001, in four different architectures: CAN, Chord, Pastry, and Tapestry. Since that time, the number of new DHT architectures have grown significantly to accommodate the existing and new features of distributed systems and applications. As the name suggests, a DHT refers to a hash table that is distributed over a plurality of locations, for example, among the various nodes of a P2P network. The foundation of a DHT is an abstract keyspace, such as a set of 160-bit strings. A keyspace partitioning scheme splits ownership of this keyspace among the participating nodes. An overlay network then connects the nodes, allowing them to find the owner of any given key in the keyspace.

Kademlia is an example DHT architecture that specifies the structure of the network and the exchange of information through node lookups. Kademlia nodes communicate among themselves using User Datagram Protocol (UDP). A virtual or overlay network is formed by the participating nodes. Each node is identified by a node ID that is 160 bits long. The node ID in Kademlia has a dual role: it identifies a given node on the network, and it also provides a direct map on how to locate a particular hash value associated with an object (e.g., a file of interest). An object can be inserted into or retrieved from the DHT logical space by calculating its hash value (e.g., in accordance with SHA-1) to produce a key. This key is then used to locate one or more particular node IDs that receive the object, or from which the object may be retrieved. Kademlia stores the objects in replica in several nodes. This redundant characteristic enables the storage or retrieval of objects even if one or more of the responsible nodes are not responding, are turned off, or are otherwise inaccessible. Each DHT node is associated with a range of keys. Accordingly, objects are added to or retrieved from a particular DHT node depending on whether their key falls within the range of keys associated with that particular DHT node.

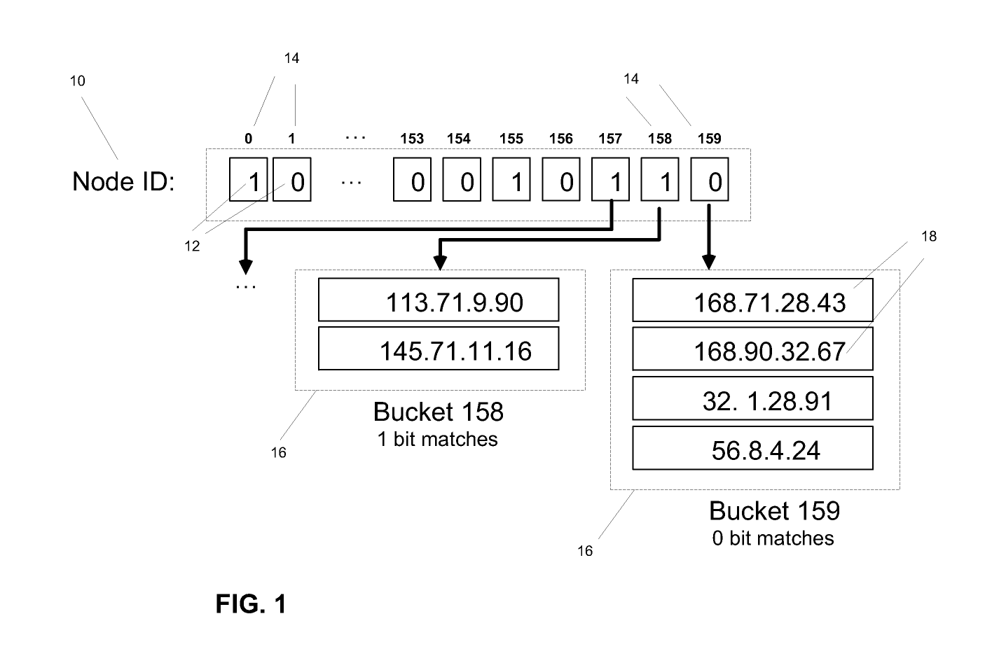

FIG. 1 illustrates a node structure and routing mechanism associated with an exemplary Kademlia DHT node. The exemplary node of FIG. 1 is identified by a node ID 10 that is 160 bits long. Individual bits 12 of the node ID 10 may be identified according to their bit positions 14 that are numbered 0 through 159. Kademlia routing is accomplished with the help of tables (also referred to as ‘buckets’). Each bucket 16 is associated with one bit position 14 of the node ID 10. Each bucket 16 may hold one or more entries 18 that provide the necessary information to locate another node in the network. In FIG. 1, the entries 18 comprise IP addresses for locating the specific nodes on the network. It is understood, however, that the entries 18 may comprise additional or alternate forms of information, such as a port ID or a node ID that may be used to identify a node.

According to the DHT architecture, each bucket is associated with nodes that reside at a specific distance from the current node ID 10. For example, bucket i may comprise contact information for nodes that satisfy the following distance criteria: 2ⁱ≦distance(current node, contact node)<2ⁱ⁺¹. The distance between the current node and the contact node is calculated using an ‘exclusive or’ (XOR) operation. For example, the distance between the two binary numbers ‘0001’ and ‘1010’ may be calculated by XORing the two numbers to obtain ‘1011,’ or decimal 11. As evident, the XOR operation also reveals the bit positions that are different between the two numbers. Referring back to FIG. 1, Bucket 159 contains one or more entries associated with node IDs that are different from the current node ID 10 in all but bit position 159. In the exemplary DHT node of FIG. 1, Bucket 159 is illustrated as containing the IP addresses for four such nodes. Similarly, Bucket 158 contains one or more entries associated with nodes IDs that meet the distance criteria for bit position 158. In the exemplary DHT structure of FIG. 1, Bucket 158 is illustrated as containing the IP addresses for two such nodes. Kademlia limits the number of entries in each bucket to a maximum of 20. If additional nodes are encountered, nodes that have remained connected to the network for shorter durations may be dropped in favor of those with longer connection durations. Buckets 0-157 (not shown) may be similarly constructed for the remaining bits of the node ID 10.

To store a new file or object in accordance with Kademlia, the 160-bit hash value of the object (e.g., hash value of filename) is calculated and sent to any node participating in the DHT. The message is forwarded from node to node through the overlay network until it reaches the nodes (typically the k closest nodes, where k is the number of replicas stored for each value) responsible for storing the information necessary to locate object. Other clients may retrieve the object by generating the hash value, and asking any DHT node to find the associated information. The message may again be routed through the overlay to the responsible node, which may reply with the stored data. Since, in Kademlia, every node that is encountered on the network is considered for inclusion in the buckets, information contained in the various nodes undergo continual updates. As such, devices that utilize Kademlia, or other similar services for enabling distributed applications, consume a great amount of energy to maintain and update the various information, or to respond to queries from myriad nodes on the network. As the various Internet-based applications and services migrate to mobile devices, efficient energy management becomes even more critical for preserving the battery power in mobile devices. A related problem is an increase in network traffic, which is likely to worsen as a node remains active for some time on a DHT network (recall that nodes with longer connection durations are preferentially retained in the buckets over the nodes with shorter connectivity). An increase in traffic not only drains the device power and computational resources, but it also consumes network resources that may result in additional network costs (e.g., a higher phone bill) associated with the device. The costs associated with the network usage may become more important when the mobile device is operating in roaming mode.

In accordance with one embodiment of the present invention, the energy consumption or network usage of a device participating in a DHT network is optimized by responding to only a fraction of messages received from the network. In Kademlia, the messages may be classified as either a query or a response. A query is initiated by other nodes on the network to solicit information. In contrast, a response is a message that is received from other nodes in response to a query initiated by the current device. In accordance with an exemplary embodiment of the present invention, the incoming messages are treated deferentially according to the type of the message received. In one exemplary embodiment, the messages (or at least the portions that identify message types) are first parsed to identify the message type. If the message is a response, it is then processed by the device. If the message is a query, it is dropped (i.e., ignored) in accordance with a dropping probability, P_{drop}.

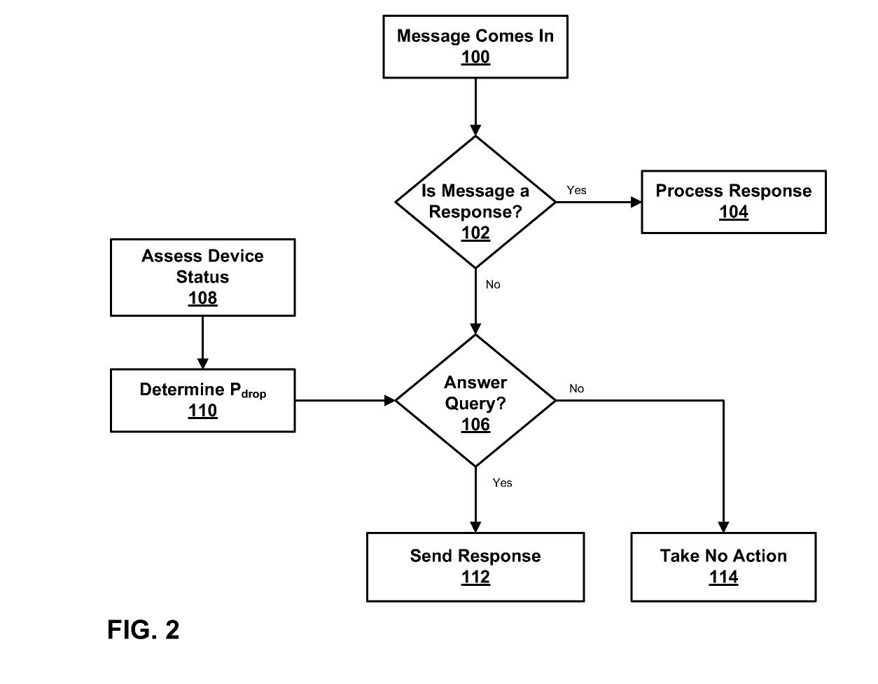

FIG. 2 illustrates a flow diagram in accordance with an exemplary embodiment of the present invention. The exemplary steps of FIG. 2 may be carried out at a device that is part of a DHT network. Once a message comes in (Step 100), the message type is determined in Step 102. As noted earlier, this task may be accomplished by parsing at least a portion of the incoming message to determine whether it is a query or a response. Once this determination is completed, if the message is a response to an earlier query by the device, the response may be processed in Step 104. If the message is not a response (i.e., it is a query or other request not initiated by the device), the determination is made as to whether to answer the query (Step 106). To accomplish this task, the device determines the value of P_{drop} (Step 110) in accordance with its assessment of the status of one or more parameters associated with the device in Step 108. In one embodiment, this assessment may include assessing the energy status of the device. Additionally, or alternatively, this assessment may include examining the status of other parameters, such as the roaming status, of the device. The assessment (Step 108) and/or determination of P_{drop} (Step 110) may be carried out periodically or based on certain alarms or battery status indications. The value of P_{drop} in accordance with an exemplary embodiment of the present invention may be equal to:

P_{drop}=0, when device is connected to an external power supply;

0<P_{drop}<1, when device is mobile; and

P_{drop}=1, when device battery power is below a predetermined threshold.

When the device is connected to an external power supply, the device may respond to all queries, as reflected by setting P_{drop} equal to zero. On the other hand, if the battery power on the device drops below a predetermined threshold, the device may decide to enter a power-saving mode by ignoring all queries initiated by other network devices and setting P_{drop} equal to 1. When the device is mobile (e.g., operating on battery power that is above a predetermined threshold), the queries may be answered with probability (1−P_{drop}), and dropped (i.e., ignored) with probability P_{drop}. P_{drop} may be selected from a suitable probability distribution function, such a Uniform probability distribution. Furthermore, P_{drop} may be set to a low value when the battery power is high, and increased to higher values as the battery power drops. As noted earlier in accordance with Step 104, if a received message is a response to an earlier query by the device, the response may be processed regardless of the energy status or roaming status of the device. Assignment of P_{drop} may be conducted in a similar fashion when the status of other device parameters are assessed. For example, P_{drop} may be set to zero when the device is not in roaming mode, and set to a value greater than zero but less than or equal to one when the device is in roaming mode. While the above example embodiments describe the assignment of P_{drop} based on a single parameter, it is understood that P_{drop} may be determined in accordance with a combination of different parameters associated with the device. For example, the probability value may be determined according to the following formula: P_{drop}=f(energy state, roaming state, x, y, z, . . . ), where x, y, and z are other parameters associated with the device that may influence P_{drop}, and the function, f, specifies how the different parameters may be combined to get the appropriate P_{drop} value.

Referring again to FIG. 2, if the decision in Step 106 is to respond to the query, the response may be sent in Step 112, otherwise no action is taken (Step 114). The exemplary embodiment of the present invention as illustrated in FIG. 2 provides an adaptive control mechanism that assesses the available battery power, roaming status, and/or connectivity to an external power supply, and subsequently, determines whether or not to respond to network messages in accordance with a probability value. This control mechanism may, for example, be implemented as a management software that runs on the network device. This mechanism allows the device to continue operating as part of the DHT network but in a manner that is less active in responding to queries made by other nodes when, for example, operating on battery power alone. In addition, the services received from other members of the DHT community remains the same even if the value of P_{drop} is less than one. The control mechanism in accordance with the various embodiments of the present invention also result in a reduction in network traffic, and thus may reduce network usage costs (e.g., phone bill) associated with the device.

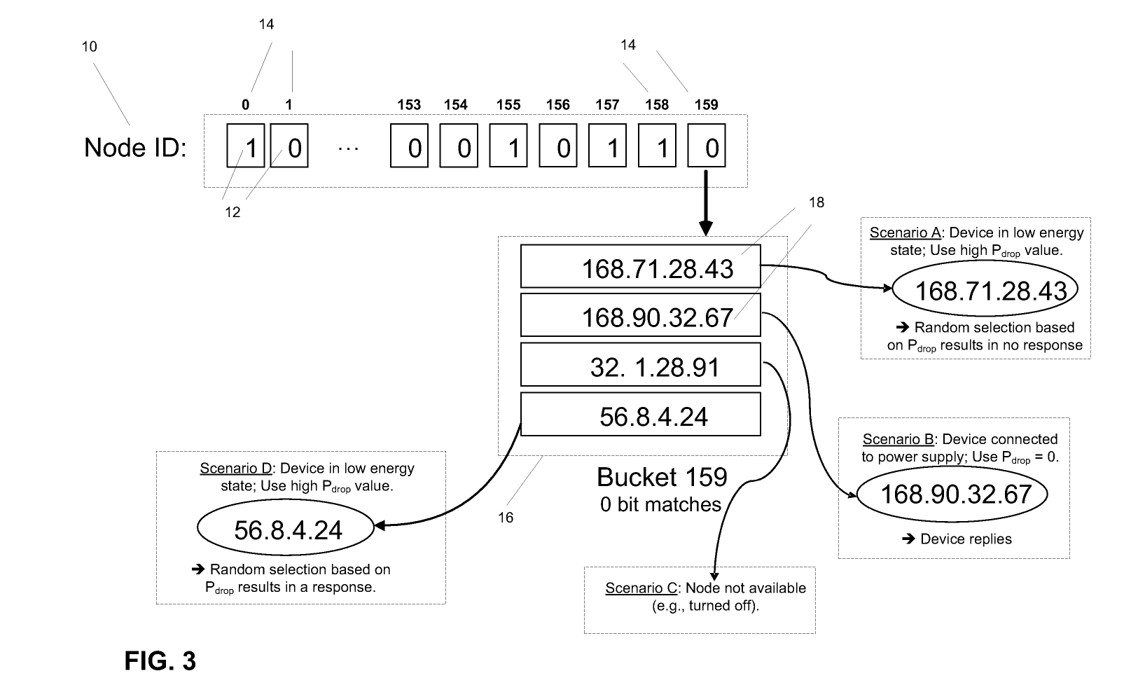

FIG. 3 provides an exemplary block diagram, illustrating the application of a dynamic power management in accordance with an exemplary embodiment of the present invention. FIG. 3 illustrates four example scenarios that may occur when a node sends parallel queries to several nodes that are listed in Bucket 159. In Scenario A, the device represented by the example IP address 168.71.28.43 is in low energy state, necessitating the usage of a high P_{drop} value for responding to network queries. In Scenario A, random selection based on a high P_{drop} value results in no response from the device. In Scenario B, the device represented by the example IP address 168.90.32.67 is connected to a power supply, thus utilizing a P_{drop} value of zero. In this scenario, the device responds to all queries. In Scenario C, the device represented by the example IP address 32.1.28.91 is not available (e.g., it is turned off), resulting in no response. In Scenario D, the device represented by the example IP address 56.8.4.24 is in low energy state. Similar to Scenario A, the device in Scenario D uses a high P_{drop} value, but in this case, the random selection process results in a response from the device.

It should be noted that if a large number of nodes all utilize large values of P_{drop}, the overall behavior of the network may start to suffer. Therefore, it is important to utilize the lowest permissible P_{drop} values in accordance with the energy status of the network device. In network communities that comprise a sizeable number of fixed DHT nodes, having high P_{drop} values for mobile devices is not likely to affect the network performance. In fact, based on experimental results and analytical computations conducted over a network of over 1 million Kademlia-based clients, the dynamic energy management methods in accordance with embodiments of the present invention reduced energy consumption by 50% while producing an average delay increase of only 10%. In these experiments, 50% of the nodes were in mobile state and the value of P_{drop} was set to 0.5.

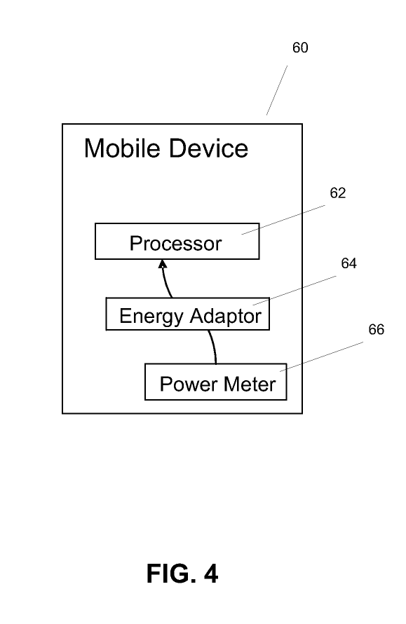

FIG. 4 illustrates a block diagram of an exemplary mobile device for implementing the exemplary embodiments of the present invention. The mobile device 60 of FIG. 4 is capable of sending and receiving messages over a network. The mobile device 60 further comprises a measurement device, such as a Power Meter 66, that is capable of measuring—or receiving measurement information relate to—the battery power of the mobile device 60. The Power Meter 66 may further be configured to determine whether or not the mobile device 60 is connected to a charging device or an external power supply. Once the energy status of the mobile device is determined, an Energy Adaptor 64 may tune DHT-related parameters, such as P_{drop} values, in accordance with the information collected from the Power Meter 66. The Processor 62 may then effect the actual responses to network messages in accordance with the parameters provided by the Energy Adaptor 64 and the type of received messages.

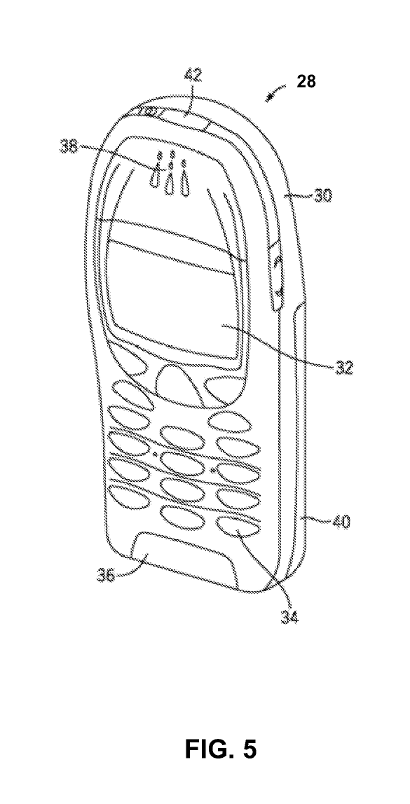

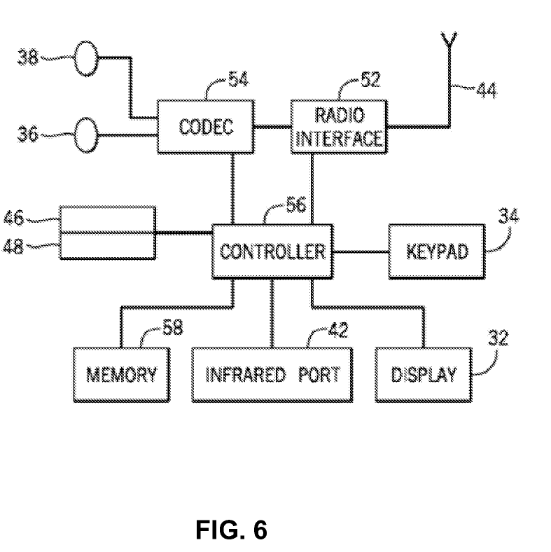

FIGS. 5 and 6 show one representative electronic device 28 which may be used as a network node in accordance to the various embodiments of the present invention. It should be understood, however, that the scope of the present invention is not intended to be limited to one particular type of device. The electronic device 28 of FIGS. 5 and 6 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method for responding to network messages, comprising:
receiving one or more network messages at a network device;
receiving information related to a status of one or more parameters of said device; and
responding to said one or more messages in accordance with the type of said messages and said information.

2. The method of claim 1, wherein said status of one or more parameters comprises energy status of said device.

3. The method of claim 1, wherein said status of one or more parameters comprises roaming status of said device.

4. The method of claim 1, wherein said one or more messages correspond to a network utilizing distributed hash tables (DHTs).

5. The method of claim 1, wherein said messages comprise at least one of a query and a response message.

6. The method of claim 1, wherein said information indicates a connectivity to an external power source.

7. The method of claim 1, wherein said information indicates a connectivity to a battery.

8. The method of claim 1, wherein said information comprises a battery power level associated with said network device.

9. The method of claim 1, wherein said information is measured periodically.

10. The method of claim 1, wherein one or more of said messages comprise a response to a message initiated by said device and said responding comprises processing said response regardless of said information.

11. The method of claim 1, wherein one or more of said messages comprise a query initiated by another device and said responding is effected in accordance with said information and a probability value associated with the likelihood of not responding to said messages.

12. The method of claim 11, wherein said information indicates a connectivity to an external power supply and said probability value is zero.

13. The method of claim 11, wherein said information indicates a battery power level below a predetermined threshold and said probability value is one.

14. The method of claim 11, wherein said information indicates a connectivity to a battery and said probability value is greater than zero but less than one.

15. A device, comprising:
a receiver configured to receive one or more network messages at a network device;
one or more measurement devices configured to collect information related to a status of one or more parameters of said device; and
a processor configured to respond to said one or more messages in accordance with the type of said messages and said information.

16. The device of claim 15, wherein said status of one or more parameters comprises energy status of said device.

17. The device of claim 15, wherein said status of one or more parameters comprises roaming status of said device.

18. The device of claim 15, wherein said one or more messages correspond to a network utilizing distributed hash tables (DHTs).

19. The device of claim 15, wherein said messages comprise at least one of a query and a response message.

20. The device of claim 15, wherein said information indicates a connectivity to an external power source.

21. The device of claim 15, wherein said information indicates a connectivity to a battery.

22. The device of claim 15, wherein said information comprises a battery power level associated with said network device.

23. The device of claim 15, wherein said information is measured periodically.

24. The device of claim 15, wherein one or more of said messages comprise a response to a message initiated by said device and said processor is configured to process said response regardless of said information.

25. The device of claim 15, wherein one or more of said messages comprise a query initiated by another device and said processor is configured to respond in accordance with said information and a probability value associated with the likelihood of not responding to said messages.

26. The device of claim 25, wherein said information indicates a connectivity to an external power supply and said probability value is zero.

27. The device of claim 25, wherein said information indicates a battery power level below a predetermined threshold and said probability value is one.

28. The device of claim 25, wherein said information indicates a connectivity to a battery and said probability value is greater than zero but less than one.

29. An apparatus, comprising:
a processor; and
a memory unit communicatively connected to the processor and including:
computer code for receiving one or more network messages at a network device;
computer code for receiving information related to a status of one or more parameters of said device; and
computer code for responding to said one or more messages in accordance with the type of said messages and said information.

30. A computer program product embodied on a computer-readable medium, comprising:
a computer code for receiving one or more network messages at a network device;
a computer code for receiving information related to a status of one or more parameters of said device; and
a computer code for responding to said one or more messages in accordance with the type of said messages and said information.
